(19) United States
(12) Patent Application Publication
(10) Pub. No.: US 2023/0004425 A1
(43) Pub. Date: Jan. 5, 2023

(54) Distributed Processing System

(71) Applicant: Nippon Telegraph and Telephone Corporation, Tokyo (JP)

(72) Inventors: Tsuyoshi Ito, Tokyo (JP); Kenji Kawai, Tokyo (JP); Kenji Tanaka, Tokyo (JP); Yuki Arikawa, Tokyo (JP); Kazuhiko Terada, Tokyo (JP); Takeshi Sakamoto, Tokyo (JP)

(21) Appl. No.: 17/782,131

(22) PCT Filed: Dec. 5, 2019
(86) PCT No.: PCT/JP2019/047633

§ 371 Date: Jun. 2, 2022

(51) Int. Cl. G06F 9/48; G06F 9/54

(52) U.S. Cl. CPC G06F 9/4843; G06F 9/54

(57) ABSTRACT

A distributed processing system to which a plurality of distributed nodes are connected, each of the distributed nodes including a plurality of arithmetic devices and an interconnect device, wherein, in the interconnect device and/or the arithmetic devices of one of the distributed nodes, memory areas are assigned to each job to be processed by the distributed processing system, and direct memory access between memories for processing the job is executed at least between interconnect devices, between arithmetic devices or between an interconnect device and an arithmetic device.

### CROSS-REFERENCE TO RELATED APPLICATIONS

This application is a national phase entry of PCT Application No. PCT/JP2019/047633, filed on Dec. 5, 2019, which application is hereby incorporated herein by reference.

### TECHNICAL FIELD

The present invention relates to a distributed processing system that processes tasks that occur by jobs from a plurality of users, at a high speed and with a high efficiency.

### BACKGROUND

Recently, the arrival of the so-called Post-Moore era, to which Moore's Law cannot be applied due to limitations of miniaturization of a silicon process, has been discussed. For the Post-Moore era, efforts have been made to break through the limitations of computational performance due to miniaturization of a silicon process for a processor such as a CPU to dramatically improve the computational performance.

As such efforts, there is a multi-core approach of providing a plurality of arithmetic cores in one processor. However, the size of one silicon chip is limited, and there are limitations to drastic improvement of a single processor. In order to exceed such limitations of a single processor, attention has been paid to a distributed processing system technology for processing a high-load task that has been difficult to process by a single device or a single server, at a high speed using a distributed processing system in which a plurality of servers equipped with arithmetic devices are connected via large-capacity interconnects.

For example, in deep learning, which is an example of a high-load job (hereinafter, a job executed in deep learning will be referred to as a learning job), inference accuracy is improved by updating, for a learning target constituted by multi-layered neuron models, a weight for each neuron model (a coefficient by which a value outputted by a neuron model at a previous stage is to be multiplied) using a large amount of sample data inputted.

In general, a mini batch method is used as a method for improving inference accuracy. In the mini batch method, a gradient computation process for computing a gradient relative to the weight for each piece of sample data, an aggregation process for aggregating gradients for a plurality of different pieces of sample data (adding up the gradients obtained for the pieces of sample data, by weight) and a weight update process for updating each weight based on the aggregated gradient are repeated.

Further, in order to perform the aggregation process in distributed deep learning to which the distributed processing system technology is applied, communication from each distributed processing node to an aggregation processing node (aggregation communication) for collecting data obtained at each distributed processing node (distributed data) to the aggregation processing node, an aggregation process for all nodes at the aggregation node, and communication from the aggregation processing node to each distributed processing node (distribution communication) for transferring data aggregated by the aggregation processing node (aggregated data) to each distributed processing node are required.

These processes, especially the gradient computation process in deep learning requires many computations. Therefore, when the number of weights and the number of pieces of inputted sample data increase in order to improve inference accuracy, time required for the deep learning increases. Therefore, in order to improve the inference accuracy but not to increase the time required for the deep learning, it is necessary to increase the number of distributed nodes and design a large-scale distributed processing system.

An actual learning job does not necessarily always require a maximum processing load. A processing load differs for each user, and there are various learning jobs from such that has an extremely heavy processing load to such that has an extremely light processing load. In conventional technologies, however, there are problems that a process for sharing a processor by a plurality of users is difficult and that, in a large-scale distributed processing system responding to a learning job with a heavy load, a process in a case where learning jobs with different processing loads occur from different users at the same time is difficult (see, for example, Non-Patent Literature 1).

FIG. 6 shows a distributed processing system in which a conventional distributed processing system is divided and used among a plurality of users. In the case of using a distributed processing system by a plurality of users, a learning job can be executed by assigning a user to each of distributed systems configured by dividing a plurality of distributed nodes 102 constituting a distributed processing system 101 as in FIG. 6. However, since a memory area for one user or job is assigned to an arithmetic device of one distributed node, split loss due to assigning one distributed node even to a job with a light processing load occurs. Therefore, there is a problem that, when a job with a light processing load and a process with a heavy processing load are performed at the same time, assignment of distributed nodes to the plurality of jobs with different processing loads becomes inefficient.

### CITATION LIST

### Non-Patent Literature

Non-Patent Literature 1: “NVIDIA TESLA V100 GPU ARCHITECTURE” by NVIDIA Corporation, p. 30, published in August 2017, Internet <https://images.nvidia.com/content/volta-architecture/pdf/volta-architecture-whitepaper.pdf>

### SUMMARY

### Technical Problem

Embodiments of the present invention have been made in view of the above situation, and an object is to provide a highly efficient distributed processing system capable of suppressing reduction in computational efficiency due to node split loss and efficiently process a plurality of learning jobs with different processing loads.

### Means for Solving the Problem

In order to solve the problem as described above, a distributed processing system of embodiments of the present invention is a distributed processing system to which a plurality of distributed nodes are connected, each of the distributed nodes including a plurality of arithmetic devices and an interconnect device, wherein, in the interconnect device and/or the arithmetic devices of one of the distributed nodes, memory areas are assigned to each job to be processed by the distributed processing system, and direct memory access between memories for processing the job is executed at least between interconnect devices, between arithmetic devices or between an interconnect device and an arithmetic device.

### Effects of Embodiments of the Invention

According to embodiments of the present invention, it becomes possible to provide a highly efficient distributed processing system capable of, when a plurality of users execute learning jobs with different processing loads at the same time, suppressing reduction in computational efficiency due to node split loss and efficiently processing the plurality of learning jobs with different processing loads.

### BRIEF DESCRIPTION OF THE DRAWINGS

FIG. 1 is a diagram showing a configuration example of a distributed processing system according to a first embodiment of the present invention.

FIG. 2 is a diagram showing a configuration example of a distributed processing system according to a second embodiment of the present invention.

FIG. 3A is a diagram showing a configuration example of a distributed processing system according to a third embodiment of the present invention.

FIG. 3B is a diagram showing an operation example of the distributed processing system according to the third embodiment of the present invention.

FIG. 4A is a diagram showing a configuration example of a distributed node according to a fourth embodiment of the present invention.

FIG. 4B is a time chart showing an operation of the distributed node according to the fourth embodiment of the present invention.

FIG. 5A is a diagram showing a configuration example of a distributed node according to a fifth embodiment of the present invention.

FIG. 5B is a time chart showing an operation of the distributed node according to the fifth embodiment of the present invention.

FIG. 6 is a diagram showing a conventional distributed processing system.

### DETAILED DESCRIPTION OF ILLUSTRATIVE EMBODIMENTS

A first embodiment of the present invention will be explained below with reference to drawings. In the present embodiment, “fixed” relates to a memory that performs direct memory access and means that memory swap out is prevented by settings. Therefore, “a fixed memory” means that a user or a job can exclusively use a particular area of the memory, and it is also possible to make a change to share the memory with another user or job or use the memory as a memory area for direct memory access for another user or job, by the settings. It is not meant that the particular area is fixed in advance and cannot be changed. The same goes for other embodiments.

Further, “job” means a process performed by a program executed by a user, and there may be a case where jobs are different though users are the same. Further, “task” means a unit of each individual computation performed by an arithmetic device or the like in a job executed by a user. The same goes for the other embodiments.

### First Embodiment

<Configuration of Distributed Processing System>

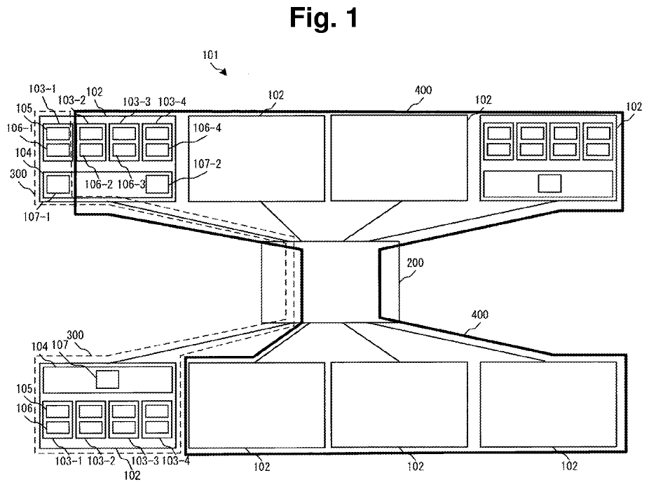

FIG. 1 is a diagram showing an embodiment of the present invention. A distributed processing system 101 is configured with a plurality of distributed nodes 102 constituting the distributed processing system 101. Each distributed node 102 is provided with a plurality of arithmetic devices 103 and an interconnect device 104. Each of the arithmetic devices 103 and the interconnect device 104 is provided with one or more memory areas.

In the configuration example of FIG. 1, a case where computational resources in the distributed processing system 101 are assigned to a job A and a job B is assumed. An arithmetic device 103-1 is an arithmetic device assigned to process the job A, and arithmetic devices 103-2 to 103-4 are arithmetic devices assigned to process the job B.

A memory area 106-1 is a memory area in the arithmetic device 103-i assigned to process the job A. A memory area 107-1 is a memory area in an interconnect device 104 assigned to the job A. Memory areas 106-2 to 106-4 are memory areas in the arithmetic devices 103, which are assigned to a user B. A memory area 107-2 is a memory area in an interconnect device 104 assigned to the user B. Further, a surrounding broken line 300 indicates computational resources used by the job A, and a surrounding solid line 400 indicates computational resources used by the job B.

<Device Configuration of Distributed Node>

Next, a specific device configuration example of a distributed node will be described. In the present embodiment, for example, a SYS-4028GR-TR2 server made by Super Micro Computer, Inc. (hereinafter referred to as “a server”) is used as each distributed node 103. On the CPU motherboard of the server, two Intel Xeon CPU processors E5-2600V4 are mounted as CPUs, and eight 32-GB DDR4-2400DIMM memory cards are mounted as a main memory.

Further, on the CPU motherboard, a 16 lane slot daughter board of PCI Express 3.0 (Gen 3) is implemented. In the slots, four NVIDIA V100 and one VCU118 Evaluation board made by Xillinx Inc. are mounted as the arithmetic devices 103 and the interconnect device 104, respectively. On the Evaluation board, two QSFP28 optical transceivers are implemented as interconnects. The distributed processing system is configured by connecting distributed nodes in a ring shape via optical fibers connected to the QSFP28 transceivers.

As the arithmetic devices, specifically, CPUs (central processing units), GPUs (graphics processing units), FPGAs, quantum computation devices, artificial intelligence (neuron) chips or the like can be used.

In the case of flexibly connecting the distributed nodes using a configuration other than a ring configuration, it is necessary to use an aggregation switch in FIG. 1. As the aggregation switch, for example, SB7800 Infini Band Switch made by Mellanox Technologies Ltd. can be used.

<Operation of Distributed Node>

Operation of the distributed nodes in the present embodiment will be explained using FIG. 1. In FIG. 1, it is assumed that a user A and a user B are executing distributed deep learning in the distributed processing system.

Specifically, after a gradient computation process, which is one of tasks of a learning job, ends, addition of pieces of gradient data is performed for pieces of gradient data of jobs obtained at the arithmetic devices, for example, among arithmetic devices in the same distributed node by a collective communication protocol such as All-Reduce. The added gradient data is further aggregated to arithmetic devices of an adjacent distributed node via the interconnects by aggregation communication and is addition-processed.

Similarly, when gradient data from a distributed node executing a learning job is aggregated at an aggregation node, the gradient data average-processed there is distributedly communicated to arithmetic devices involved in the aggregation and shared. Learning is repeated based on the shared gradient data, and learning parameters are updated at each arithmetic device.

In such aggregation communication and distribution communication, in order to move gradient data at a high speed, memory areas included in devices are fixedly assigned, and data transfer is performed between fixedly assigned memory addresses of the memory areas between an arithmetic device and an interconnect device in a distributed node and between interconnect devices of different distributed nodes. The former data transfer in a distributed node is called direct memory access, and the latter data transfer between distributed nodes is called remote direct memory access. Conventionally, in the four arithmetic devices in the distributed node 102 on the upper left of FIG. 1, memories of the distributed node are assigned to a single job, and the memories of the one distributed node 102 are occupied by one user.

In the present embodiment, however, the fixed memory area 106-i for the job A is assigned to the leftmost arithmetic device 103-1, and the fixed memory areas 106-2 to 106-4 for the job B are assigned to the other three arithmetic devices 103-2 to 103-4, among the four arithmetic devices of the distributed node on the upper left of FIG. 1. Further, in the interconnect device 104 in this distributed node 102, the individual fixed memory areas 107-1 and 107-2 are assigned to the job A and job B, respectively.

By assigning memories of arithmetic devices and an interconnect device in one distributed node to each of a plurality of jobs as described above, direct memory access accompanying the job A is executed between the fixed memory area 106-1 provided in the leftmost arithmetic device 103-1 of the distributed node on the upper left of FIG. 1 and the fixed memory area 107-1 for the user A in the interconnect device 104. Further, as for access between different distributed nodes, remote direct access memory is performed between the fixed memory area 107-1 for the user A in the interconnect device 104 and a fixed memory area 107 assigned to an interconnect device 104 of a distributed node 102 on the lower left of FIG. 1.

Similarly, for the job B, direct memory access accompanying the job B is executed between the fixed memory areas 106-2 to 106-4 assigned to the right-side three arithmetic devices 103-2 to 103-4 in the distributed node on the upper left of FIG. 1 and the fixed memory area 107-2 for the user B in the interconnect device 104. Further, as for access between different distributed nodes, remote direct access memory is performed between the fixed memory area 107-2 for the user B in the interconnect device 104 and a fixed memory area assigned to an interconnect device of a distributed node 102 on the upper right of FIG. 1.

As described above, in the present embodiment, by providing, for each of a plurality of jobs, a fixed memory area for the job in a device of each distributed node, it is possible to realize distributed processing corresponding to the number of users or jobs using the distributed processing system, not for each distributed nodes but for each arithmetic device. Therefore, in the present embodiment, it is possible to realize a distributed processing system capable of highly efficient distributed processing according to the number of users and the magnitude of processing load of a learning job.

### Second Embodiment

<Configuration of Distributed Processing System>

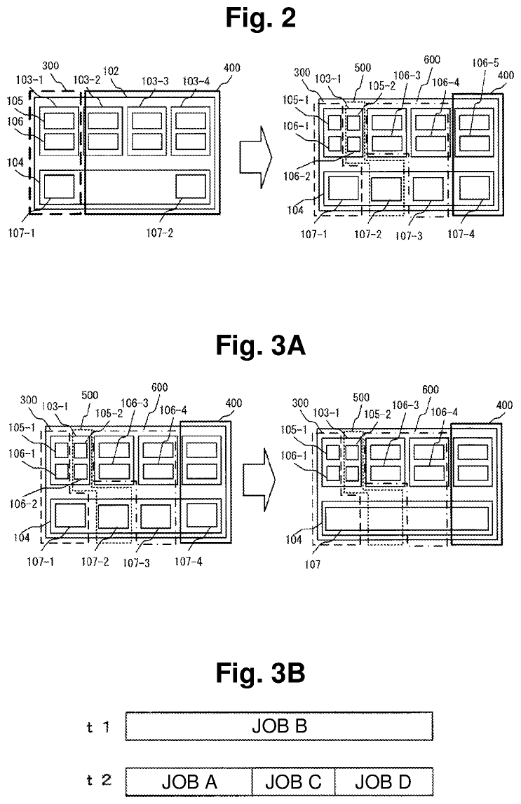

FIG. 2 is a diagram showing a second embodiment of the present invention. The second embodiments shows a state of a memory assignment process in a case where, in addition to the job A and the job B of the first embodiment, a job C and a job D are further added, and a load of a learning job of each of added users is small. In FIG. 2, a dotted line 500 indicates fixed memory areas in the arithmetic device and the interconnect device for the job C, and the fixed memory area 106-2 for the job C coexists with the fixed memory area 106-i for the job A in the same arithmetic device 103-1. The memory area 107-2 is a fixed memory area in the interconnect device 104 assigned to the job C. The memory areas 106-3 and 106-4 are fixed memory areas in the arithmetic devices 103-2 and 103-3, which are assigned to a user D. A memory area 107-3 is a fixed memory area in the interconnect device 104 assigned to the user D.

<Operation of Distributed Node>

In the second embodiment, it is assumed that, in addition to requests for the learning jobs A and B, the learning jobs C and D with a processing load lighter than the processing load of the jobs A and B are newly requested by users. Since the processing load of the job C is the lightest, the small memory area 106-2 is assigned to a user C separately from the memory area 106-i assigned to the job A, in the leftmost arithmetic device 103-i on the upper left that has been used by the user A. Further, since the processing load of the job D is heavier than the processing load of the job C, the two arithmetic devices 103-2 and 103-3 among the arithmetic devices used by the job B are assigned to the job D. At this time, assignment is changed to assign fixed memory areas assigned to the job B are assigned to the job D.

Next, in the interconnect device 104, fixed memory areas for the job C and the job D are secured in addition to the fixed memory areas assigned to the job A and the job B. Thus, assignment of a fixed memory area to each job is performed in each device, and a learning job by each user is executed in each arithmetic device.

As described above, in the second embodiment, a configuration is made to individually assign a fixed memory area in a device to each job and, furthermore, cause fixed device areas for a plurality of jobs to coexist in one arithmetic device. Therefore, it is possible to flexibly divide a distributed processing system not into units of distributed nodes but into units of arithmetic devices each of which constitutes a distributed node and, furthermore, into units of fixed memory areas in the arithmetic devices. Therefore, in the second embodiment, it is possible to provide a distributed processing system capable of processing a plurality of jobs with different magnitudes of processing loads efficiently at a high speed.

### Third Embodiment

<Configuration of Distributed Processing System>

FIGS. 3A and 3B are diagrams showing a configuration example and an operation example of a distributed processing system according to a third embodiment of the present invention. In the second embodiment, a fixed memory area for each of a plurality of jobs is provided in an interconnect device. In the third embodiment, a memory area shared by a plurality of jobs is provided in an interconnect device.

<Operation of Distributed Node>

In the present embodiment, when the number of jobs increases, and fixed memory areas to be assigned to the jobs are insufficient, one fixed memory area is shared by a plurality of jobs. When all of fixed memory areas in the interconnect device that can be assigned as fixed memory areas are consumed as fixed memory areas for the job B, there are no fixed memory areas to be assigned to the other jobs A, C and D. Therefore, the memory areas of the interconnect device 104 are set as a fixed shared memory area 107 to be shared by the jobs A, B, C and D as shown in the right diagram in FIG. 3A.

FIG. 3B is shows a specific example of an aspect of the sharing. In the example of FIG. 3, the job B performs direct memory access using all the fixed memory area 107 at time t1, and the users A, C and D not requiring a large fixed memory area share the fixed memory at the same time at time t2.

By not assigning fixed memory areas to a plurality of jobs individually but causing the fixed memory areas to be a shared memory to be shared by the plurality of jobs, it is possible to provide a distributed processing system that can be used by a plurality of jobs even if resources to be assigned as fixed memory areas are small like an interconnect device. According to the present embodiment, it is possible to provide a distributed processing system capable of processing a plurality of jobs efficiently at a high speed.

Further, in the case of sharing a fixed memory area by time division, a bandwidth secured for direct memory access can be occupied by one user. Therefore, it is possible to preferentially assign a user from whom high-speed data transfer is required, and there is a merit that QoS for each job can be provided.

### Fourth Embodiment

<Configuration of Distributed Processing System>

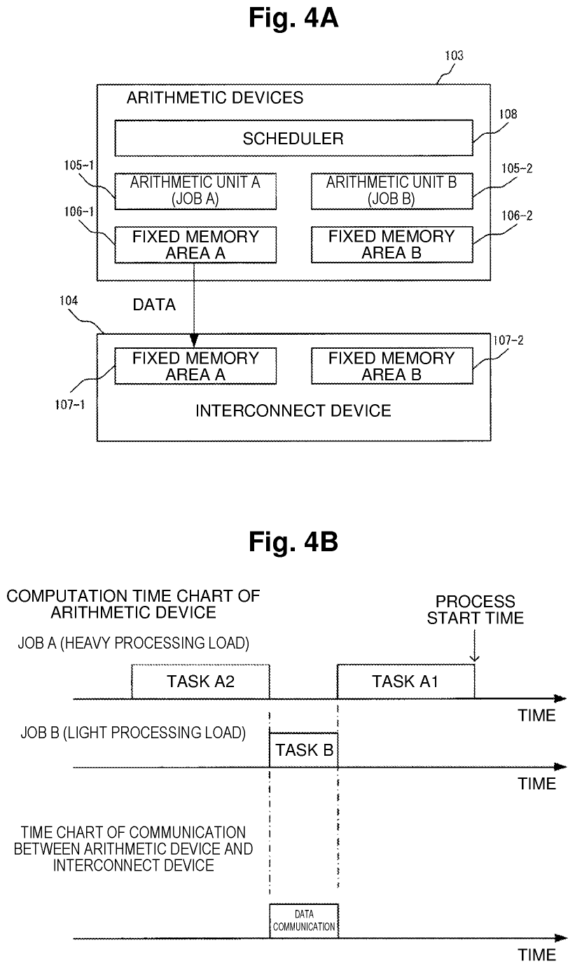

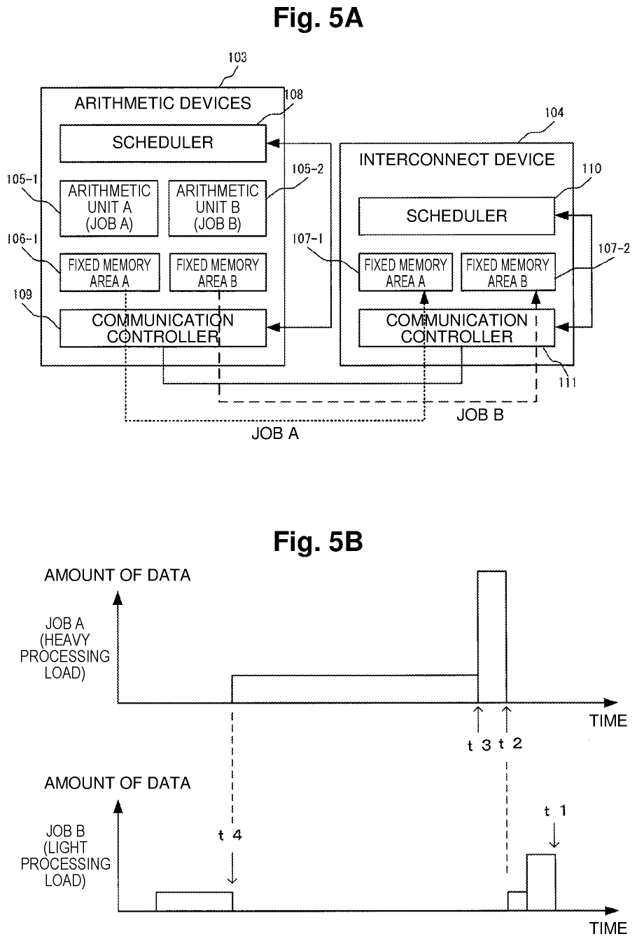

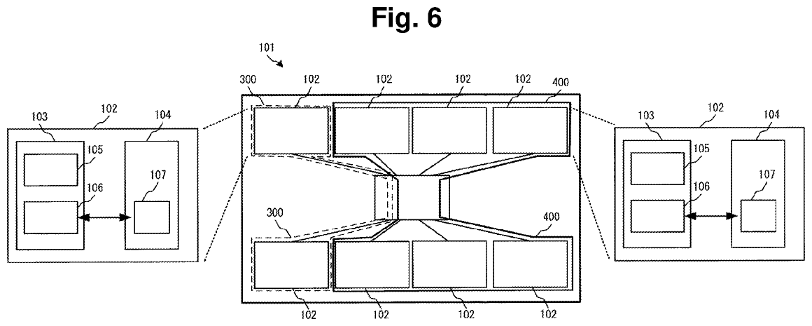

FIGS. 4A and 4B are diagrams showing a configuration example and an operation time chart of a distributed node according to a fourth embodiment of the present invention.

In an arithmetic device 103 in FIG. 4A, an arithmetic unit A 105-1 and a fixed memory area A 106-i are assigned for a job A, and an arithmetic unit B 105-2 and a fixed memory area B 106-2 are assigned for a job B. In an interconnect device 104, a fixed memory area A 107-1 is assigned for the job A, and a fixed memory area B 107-2 is assigned for the job B.

FIG. 4B shows a time chart of computation in the arithmetic device 103 and a time chart of communication between the arithmetic device and the interconnect device. In the time chart of the computation in the arithmetic device 103, a task A1 and a task A2 are computation time for the job A in the arithmetic device 103, and computation time for a task B is computation time for the job B. The time chart of communication between the arithmetic device and the interconnect device shows time of communication of computation data of the job A between the arithmetic device and the interconnect. <Operation of Distributed Node>

In the computation time chart in FIG. 4B, the job A is started at start time. When the task A ends, inter-memory direct memory access is performed between the arithmetic device and the interconnect device. In the example of deep learning, aggregation and sharing of computation results among distributed nodes are performed via communication by a protocol called collective communication such as All-Reduce. At this time, when the user B starts a job (in this case, it is assumed that communication does not occur between the arithmetic device and the interconnect after the task B), computation of the task B accompanying the start of the job B cannot be started while the job A is being executed.

When All Reduce communication of the job A is executed, however, computation for the job A by the arithmetic device is not performed. Therefore, during the time, a part of the task of the job B can be executed. For example, a case is assumed where 1-GB gradient data is sent in the job A by direct memory access. When the 1-GB data of the job A is transferred to the interconnect device 104, the interconnect device 104 starts direct memory access to the memory of the interconnect device from a cash memory or a global memory in an adjacent distributed node. When the bandwidth for the interconnects is 100 Gbit/s, time required to transfer the 1-GB data is 80 milliseconds. During the 80 milliseconds, the task of the job B can be executed.

If it is assumed that the tasks A1 and A2 of the job A are repeatedly executed, for example, such that, after the execution time of 800 milliseconds of the task A of the job A, the task A of the job A is executed next, the rate of the execution time of the job A relative to operation time of all the arithmetic devices is 90% when the job A is processed. Here, if the rate of the load of the job B is assumed to be 10% of the load of the job A, all the remaining 10% operation time of the arithmetic devices that the job A could not use up can be utilized, and the efficiency of the arithmetic devices becomes 100%.

Thus, by providing a dedicated fixed memory area for transferring processing data of a predetermined job to an interconnect device, in an arithmetic device and performing scheduling control of direct memory access processes for a plurality of jobs in the arithmetic device, it is possible to increase operation time of the arithmetic device and improve computational efficiency. According to the present embodiment, it is possible to provide a distributed processing system capable of processing a plurality of jobs efficiently at a high speed.

### Fifth Embodiment

(Operation of Distributed Node)

FIGS. 5A and 5B are diagrams showing a configuration example and an operation time chart of a distributed node according to a fifth embodiment of the present invention. In the fifth embodiment, a communication controller having a communication control function generated by a hardware circuit is installed between memories that perform direct memory access.

In the present embodiment, a case where there are a job A with a heavy load and a job B with a light load, and direct memory accesses for the job A and the job B are performed at the same time is assumed. As shown in FIG. 5A, a fixed memory area is assigned to each of a plurality of jobs in one arithmetic device. Therefore, if direct memory accesses are performed at the same time, bandwidths for the direct memory accesses conflict. Further, if there is a high-priority job among the plurality of jobs, it is necessary to process the high-priority task first.

In FIG. 5B, it is assumed that a job of a user B is started at time t1, the task is processed by an arithmetic device, and, after that, a job of a user A is started at time t2. Since the user A has a high priority, a communication controller 109 stops direct access by the user B when the direct access by the user B is started at the time t2, and immediately feeds back information about it to a scheduler 108 of the arithmetic device 103.

The scheduler 108 of the arithmetic devices 103 causes direct memory access for the job A to start at time t3 after the computation of the job A is completed. When detecting end of data transfer for the job A, the communication controller 109 feeds back it to the scheduler 108 and re-starts the direct memory access for the job B at time t4.

Thus, by realizing a communication controller that, for high-priority memory, causes direct memory access to be preferentially performed, by a hardware circuit between fixed memory areas that perform direct memory access between an arithmetic devices and an interconnect device, a process of, when a high-priority job occurs, causing data transfer for a low-priority job to wait and performing the data transfer for the low-priority job after data transfer for the high-priority job is completed becomes possible, without deteriorating latency and bandwidth characteristics. Therefore, even when there are a plurality of jobs with different priorities, it is possible to improve processing efficiency of a high-priory job.

As for the hardware circuit that realizes the communication controller, by equipping the communication controller 109 on the direct memory access transmission side with a function of giving an identifier that associates a job and data to be transmitted, and equipping a communication controller 111 on the reception side with an identification function of identifying for which job the direct memory access is, it is possible to perform identification of each job on the reception side at a high speed even when complicated control such as priority processing is performed on the transmission side. Therefore, it is preferable for efficient and highly reliable control to provide the identifier giving function for associating a user and the identification function between memories for direct memory access.

When data is transmitted from the interconnect device 104 to the arithmetic device 103, a similar process is also performed by a scheduler no of the interconnect device 104 and the communication controllers in and 109.

### INDUSTRIAL APPLICABILITY

Embodiments of the present invention can be used for a large-scale distributed processing system that performs a large amount of information processing or a distributed processing system that processes a plurality of jobs with different loads at the same time. Especially, the present invention is applicable to a system that performs machine learning in neural networks, large-scale computation (such as large-scale matrix operation) or a large amount of data information processing.

### REFERENCE SIGNS LIST

101 Distributed processing system

102 Distributed node

103-1 to 103-4 Arithmetic device

104 Interconnect device

105, 105-1 to 105-4 Arithmetic unit

106, 106-i to 106-4 Memory area (arithmetic device)

107, 107-1 to 107-2 Memory area (interconnect device).

1-7. (canceled)

8. A distributed processing system to which a plurality of distributed nodes are connected, each of the distributed nodes comprising:
a plurality of arithmetic devices; and
an interconnect device, wherein in the interconnect device or the plurality of arithmetic devices, one or more memory areas are configured to be assigned to each job to be processed by the distributed processing system, and wherein direct memory access between memories for processing a job is executed at least between interconnect devices, between arithmetic devices, or between an interconnect device and an arithmetic device.

9. The distributed processing system according to claim 8, wherein the memory areas for processing a plurality of jobs, respectively, are assigned to a first arithmetic device of the arithmetic devices.

10. The distributed processing system according to claim 9, wherein, during time during which a process for a particular job is not being executed, the first arithmetic device is configured to execute a process for another job different from the particular job.

11. The distributed processing system according to claim 8, wherein the memory areas for processing a plurality of jobs, respectively, are assigned to one interconnect device.

12. The distributed processing system according to claim ii, wherein the memory areas for processing the plurality of jobs, respectively, are assigned to the one interconnect device by time division.

13. The distributed processing system according to claim 8, wherein the distributed node is configured to select direct memory access to be executed from among direct memory accesses for a plurality of jobs, according to priorities of the plurality of jobs, each of the direct memory accesses being executed at least between interconnect devices, between arithmetic devices, or between an interconnect device and an arithmetic device.

14. The distributed processing system according to claim 13, wherein
data transferred by the direct memory access has an identifier that is different for each of the plurality of jobs; and
the interconnect device is configured to select data transferred by the direct memory access based on the identifier.

15. A distributed node comprising:
a plurality of arithmetic devices; and
an interconnect device, wherein in the interconnect device or the plurality of arithmetic devices, one or more memory areas are configured to be assigned to each job to be processed by a distributed processing system, wherein direct memory access between memories for processing a job is executed at least between interconnect devices, between arithmetic devices, or between an interconnect device and an arithmetic device, wherein the distributed node is a part of the distributed processing system.

16. The distributed node according to claim 15, wherein the memory areas for processing a plurality of jobs, respectively, are assigned to a first arithmetic device of the arithmetic devices.

17. The distributed node according to claim 16, wherein, during time during which a process for a particular job is not being executed, the first arithmetic device is configured to execute a process for another job different from the particular job.

18. The distributed node according to claim 15, wherein the memory areas for processing a plurality of jobs, respectively, are assigned to one interconnect device.

19. The distributed node according to claim 18, wherein the memory areas for processing the plurality of jobs, respectively, are assigned to the one interconnect device by time division.

20. The distributed node according to claim 15, wherein the distributed node is configured to select direct memory access to be executed from among direct memory accesses for a plurality of jobs, according to priorities of the plurality of jobs, each of the direct memory accesses being executed at least between interconnect devices, between arithmetic devices, or between an interconnect device and an arithmetic device.

21. The distributed node according to claim 20, wherein:
data transferred by the direct memory access has an identifier that is different for each of the plurality of jobs; and
the interconnect device is configured to select data transferred by the direct memory access based on the identifier.
